(19) United States
(12) Patent Application Publication
(10) Pub. No.: US 2009/0055187 A1
(43) Pub. Date: Feb. 26, 2009

(54) Conversion of text email or SMS message to speech spoken by animated avatar for hands-free reception of email and SMS messages while driving a vehicle

(76) Inventors: Howard Leventhal, Lindenhurst, IL (US); Anan Yaagoub, Lemont, IL (US)

Correspondence Address: BREFFNI X. BAGGOT, 2650 EDISON AVENUE, GRANITE CITY, IL, 62040, US

(21) Appl. No.: 11/894,440

(22) Filed: Aug. 21, 2007

(51) Int. Cl. G10L 13/08

(52) U.S. Cl. 704/260; 704/E13.001

(57) ABSTRACT

Subscribers can access and listen to their email while they drive, access to the email messages being hands-free so a person can listen to email while they drive. In further accord with the present invention, a selectable avatar speaks the email message. And, the invention provides unified messaging such that SMS and email are unified and present and spoken by the avatar, so the subscriber need not access two devices (an instant message device, and an email device). Additionally, the invention can convert natural language to an acronym to be spoken by the avatar, and can convert acronyms in a message to natural language spoken by the avatar; subscriber selects the desired one of these two.

### CROSS-REFERENCE TO RELATED APPLICATIONS

This patent claims priority to U.S. Provisional Patent Application Ser. No. 60/836,937 filed Aug. 22, 2006, which is incorporated by reference in its entirety.

### TECHNICAL FIELD

The present invention relates to the wireless reception of messages, and in particular email messages received on a car PC, mobile phone, or handheld computer.

### BACKGROUND OF THE INVENTION

Research by Telestra (Telestra.com) shows 58 percent of motorists aged 17 to 29 read a text message, or SMS, while driving.

One-third of drivers under 30 surveyed felt they could safely take their eyes off the road to send a text message or talk on the phone. And if they could not manage to send the message while driving, traffic lights provided the perfect texting opportunity for more than 30 percent of young drivers, the research

Men are the worst offenders, with more males than females making and answering calls while driving. Five percent of males even agreed that chatting on a hand-held phone affected their driving.

But it is not just younger drivers who cannot resist the temptation of a ringing phone.

Across all age groups, one in three motorists admitted to making calls from their mobile at least once a week, and more than half said they answered the phone in the car. A survey by Nationwide Mutual Insurance found that one in five people text while driving. The numbers jump to one in three among 18-34 year olds, and insurers predict that this trend will only increase as more people get access to mobile devices with messaging technologies.

In May, 2007 the state of Washington passed a ban on texting while driving, and a number of other states, including New York, California and Florida, are considering similar laws.

A solution is needed.

### SUMMARY OF THE INVENTION

It is an object of the present invention to allow a person to get his email through an audio message, that is without reading his email.

According to the present invention, subscribers can access and listen to their email while they drive, access to the email messages being hands-free so a person can listen to email while they drive. In further accord with the present invention, a selectable avatar speaks the email message. Third, the invention provides unified messaging such that SMS text messages and email are unified and presented and spoken by an avatar, so the subscriber need not access two devices (an instant message device, and an email device) but receive both kinds of messages from one device.

These and other advantages will become readily apparent to those skilled in the art based upon the disclosure contained herein.

### BRIEF DESCRIPTION OF THE DRAWINGS

FIG. 1 is a diagram of the present invention.

FIG. 2 is a diagram of the present invention.

FIG. 3 is a diagram of the present invention using a personal computer.

FIG. 4 is a diagram of the present invention using a handheld computer.

FIG. 5 is a flowchart of the email reader application for a personal computer.

FIG. 6 is a flowchart of the email reader application for a personal computer.

FIG. 7 is a flowchart of the email reader application for a personal computer.

FIG. 8 is a flowchart of the email reader application for a personal computer.

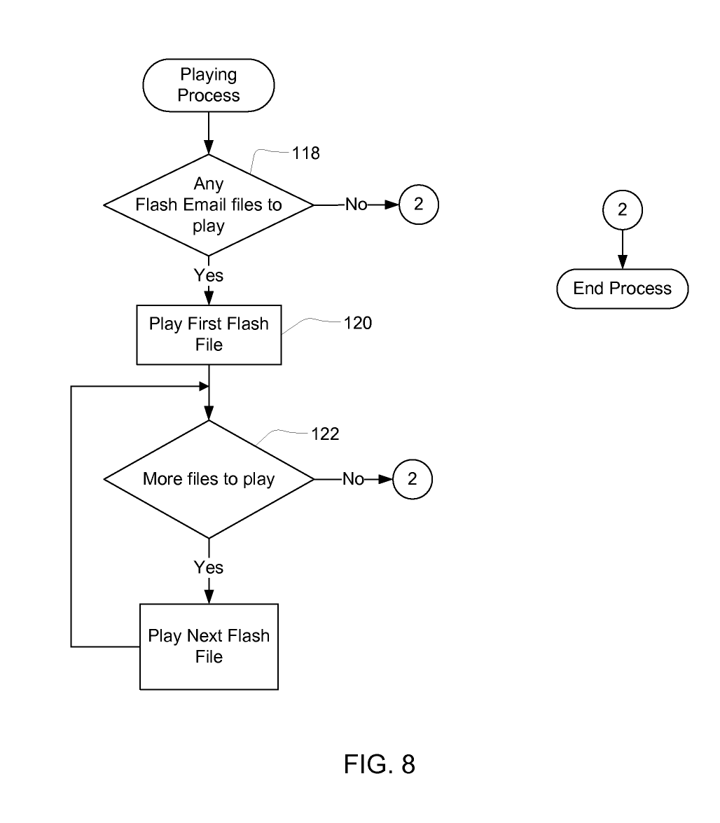

FIG. 9 is a flowchart of the email reader application for a cell phone or handheld computer.

FIG. 10 is a flowchart of the email reader application for a cell phone or handheld computer.

FIG. 11 is a flowchart of the email reader application for a cell phone or handheld computer.

FIG. 12 is a flowchart of the email reader application for a cell phone or handheld computer.

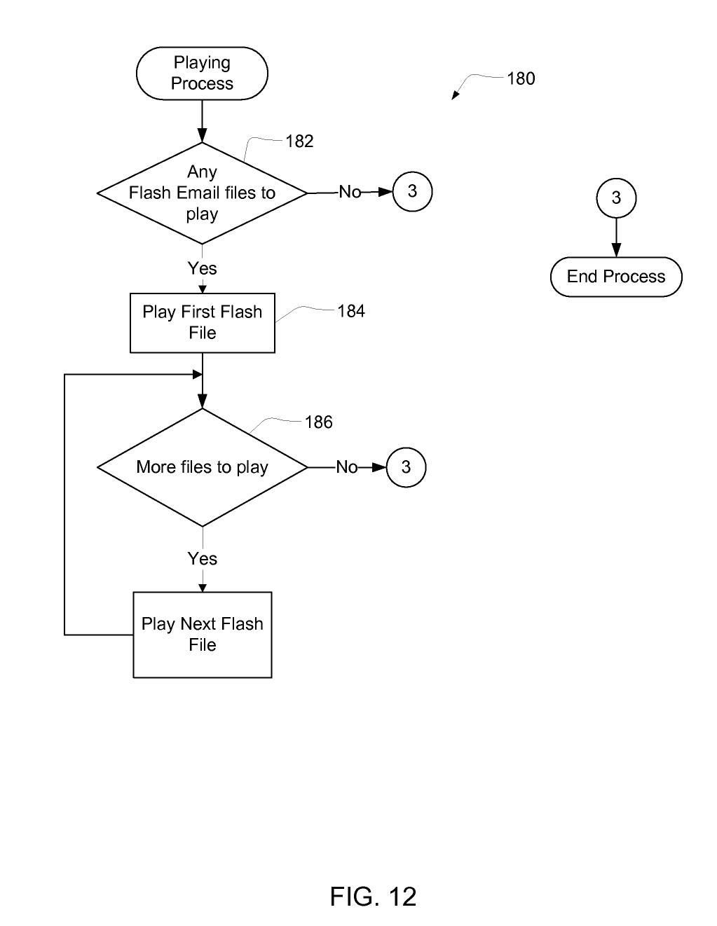

### DETAILED DESCRIPTION OF THE INVENTION

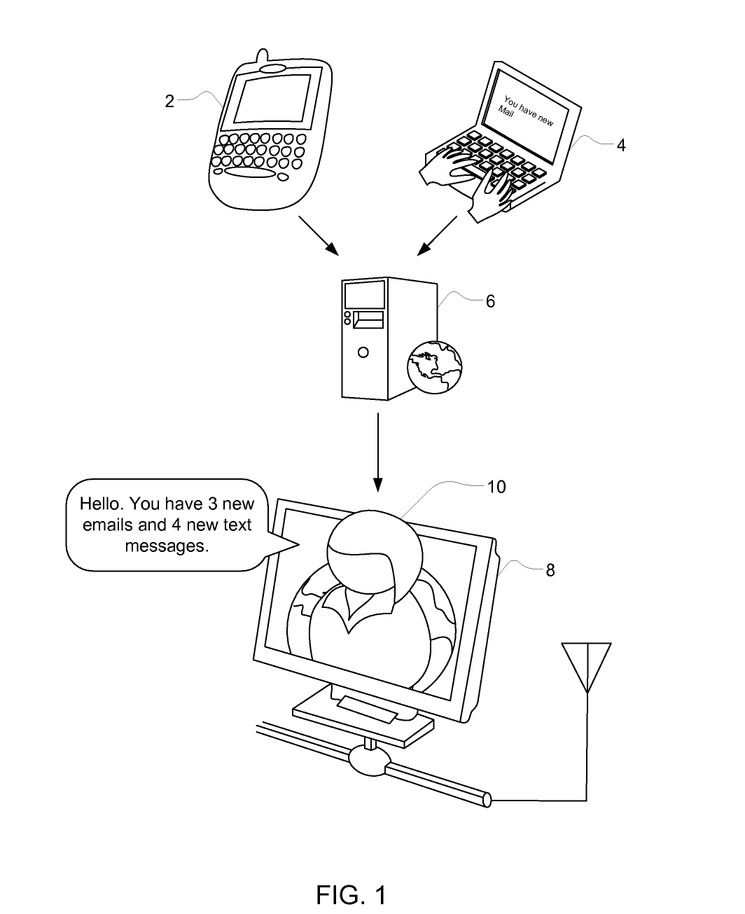

The invention renders an email and text message on a screen display of an animated avatar synchronized with an audio version of the email or text message. The invention can work on a mobile device including a personal computer, smart phone, cellphone, or handheld computer. It is understood that mail and email are used interchangeably as are the terms user and subscriber. In FIG. 1, an SMS text message sender 2, a POP email sender 4 both can send their messages through a web server 6 to a wireless mobile internet terminal 8 where the SMS and email can be read aloud as a sound file by an avatar 10. This unified message system avoids the need to check two devices for incoming messages (for example a Blackberry, and a personal computer) and avoids the need to read the message because the message is spoken. If the wireless mobile internet terminal sits on an automobile dashboard, a user can listen to email and SMS messages rather than read them and therereby drive more safely for his benefit and the benefit of others. This makes for safe driving. The invention can, but is not limited to, connect to the Internet through the Verizon Wireless EV-DO high-speed network. When fully installed on a compatible device, Vivee, yields full wireless Internet connectivity at speeds on par with many DSL services.

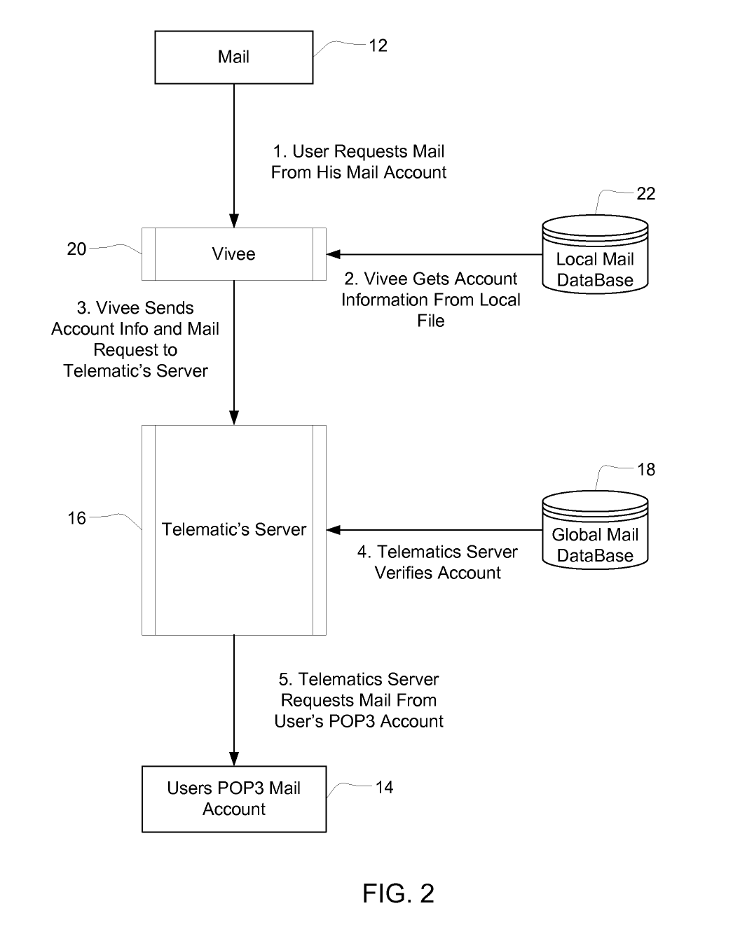

In FIG. 2, a user 12 has a POP3 email account 14. First, a telematics server 16 gets email from the POP3 email account 14 of the user. Second, the telematics server 16 saves mail to a global mail database 18. Third, the telematics server 16 sends a mail list to a Vivee 20 (short for Voice Interactive Voice Enhanced Email). Fourth, Vivee 20 updates mail information in a local database. 22 Fifth, Vivee 20 displays available mail to user 12. Vivee 20 can be a handheld computer, smartphone, or personal computer.

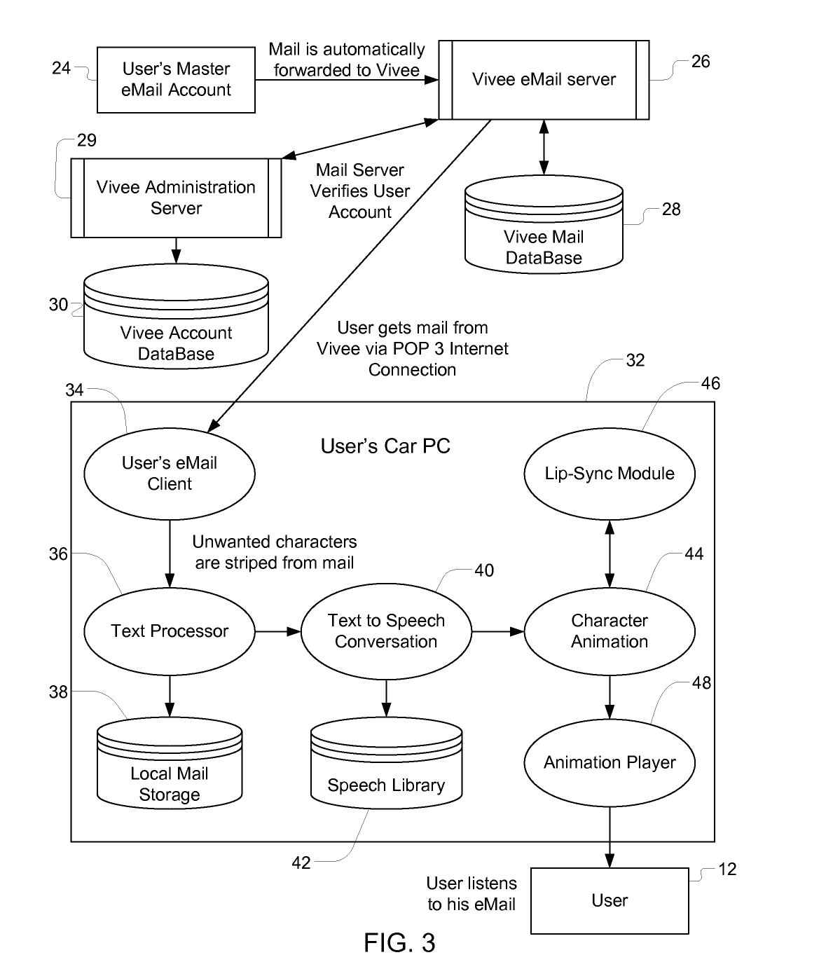

In FIG. 3, user 12 has a master mail (or email) account which forwards mail automatically to a Vivee email server 26. The Vivee email server 26 sends signals to and receives signals from a Vivee mail database 28. The Vivee mail server 26 also sends signals to and receives signals from a Vivee administration server 29 for the purpose of verifying a user account. The Vivee administration server 29 in turn communicates mail both ways with a Vivee account database 30. Further, the Vivee mail server 28 provides mail via a POP3 internet connection to a user car personal computer 32. A user email client 34 resides on the personal computer 32. Unwanted characters are stripped from piece of mail and the mail is provided to a text processor 36. After text processing the mail is stored locally 38 and converted to a speech signal 40. The speech signal is stored in a speech library 42 on the car personal computer 32. The speech signal is also provided to a character animator 44 for providing an avatar animated in synchronization with the text email. The character animator 44 is responsive to a lip-synch module 46 which receives the speech signal and together with the character animator 44 provides an avatar signal to the user 12 via a display on an animation player 48. This display includes a visual component and an audio component which plays the speech signal in synchronization with the lip movement of the chosen avatar 10. The user 12 can choose to look at the avatar 10, listen to the mail, or both.

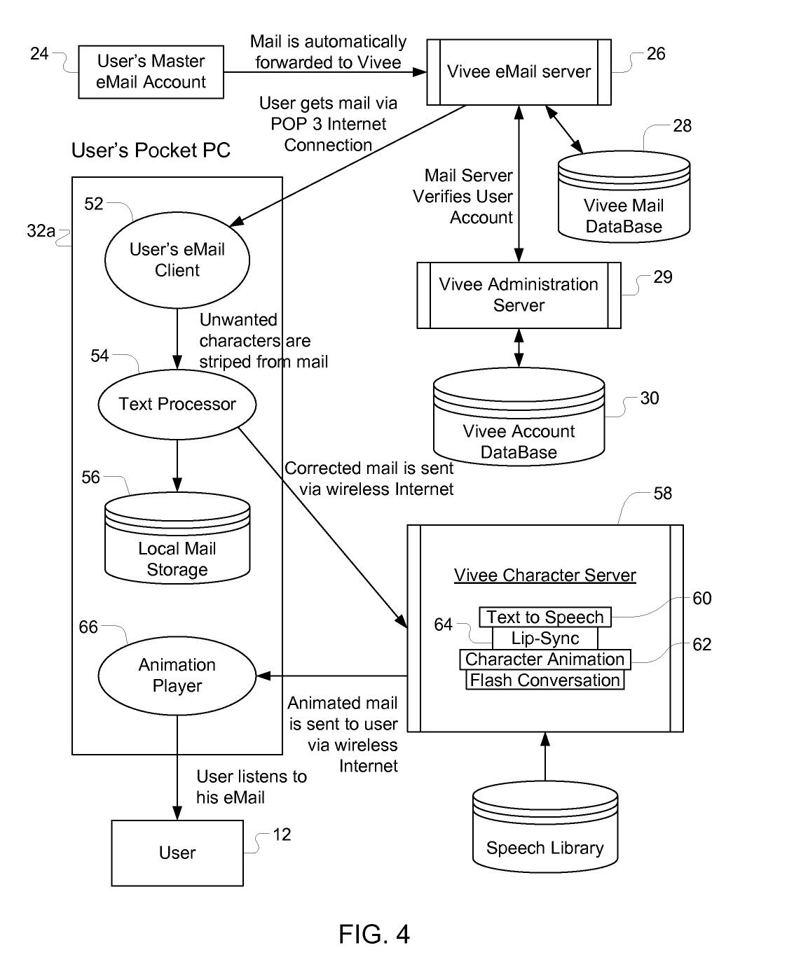

FIG. 4 shows a view of the present invention for use on a mobile device 32a. A mobile device, or mobile handheld computing device, can include as a handheld computer, PocketPC, Palm, or the like. The operation of the invention differs somewhat from that shown in FIG. 2. A handheld computer is typically constrained by less computing power than might be found on a stand-alone personal computer. A user 12 has a master mail account 24 which forwards mail automatically to a Vivee mail server 26. The Vivee mail server 26 is available from Mail Enable (MailEnable.com), a powerful, scalable, hosted messaging platform. Mail Enable provides multi domain support and integrates with Microsoft's Management Console for management of users and domains. The base configuration of Mail Enable stores the configuration information in tab delimited files in the config folder. The Enterprise version supports storing this data in either SQL or MySQL. The Vivee email server 26 sends signals to and receives signals from a Vivee mail database 28. The Vivee mail server 26 also sends signals to and receives signals from a Vivee administration server 29 for the purpose of verifying a user account. The Vivee administration server 29 in turn communicates mail both ways with a Vivee account database 30. Further, the Vivee mail server 26 provides mail via a POP3 internet connection to a handheld computer 50, such as a PocketPC. A user email client 52 resides on the handheld computer 50. Unwanted characters are stripped from piece of mail and the mail is provided to a text processor 54. After text processing, the mail is stored locally 56 but not converted to a speech signal. Instead, the processed text message is sent by wireless internet to a Vivee character server 58. On the Vivee character server, the processed text message is converted to an audio speech signal. One job of the Vivee character server 58 is conversion: to receive a text file and provide a flash file. The speech signal is provided to a character animator 62. The character animator 62 is responsive to a lip-synch module 64 which receives the speech signal and together with the character animator 62 provides an avatar signal in flash format to the user via a display on an animation player 66. This display includes a visual component which speaks the text of the mail and an audio component which plays the speech signal in synchronization with the lip movement of the chosen avatar 10.

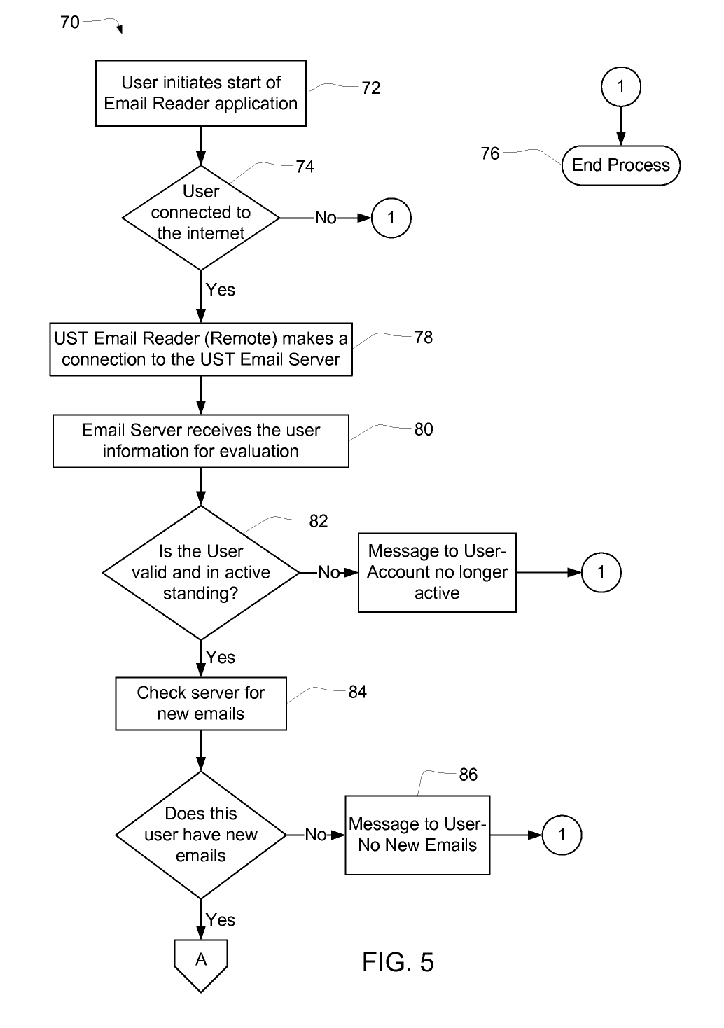

FIG. 5 is a flowchart of the email reader application for a personal computer 32. The email reader application is responsible for making the connection to the server, verifying user authority, transfer the emails to the mobile device playing the email. Each customer of this service will receive an email address at Vivee.com. It will be the responsibility of a user to setup forwarding to their Vivee.com email address for any other email accounts they would like to access through the Email Reader. A user (or subscriber) 12 starts an email reader application 70 which first determines 72 if the user 12 is connected to the wireless network (such as the internet) and if not the email reader application 70 ceases 76. Otherwise, the email reader makes a connection 78 to the mail server 26 and then the mail server 26 gets user information for evaluation 80. Standard internet protocol POP3 is used to make the connection to the server 26. This user information can include a user identity for comparison with a list of active users who have or have not paid their bill for using the invention. By getting the user information, the invention can inform delinquent subscribers of their delinquency and send them a message as to how to resolve the delinquency. The invention can receive credit card information in real-time such that users need not be frustrated by a service lapse. Seriously delinquent users can be informed of their status and how they can reactivate their accounts should they choose to do so. If a query 82 as to whether the subscriber is valid and active is answered in the negative, the email reader application 70 exits 76. If the query 82 answers in the affirmative the mail server 202 is checked for new emails 84.

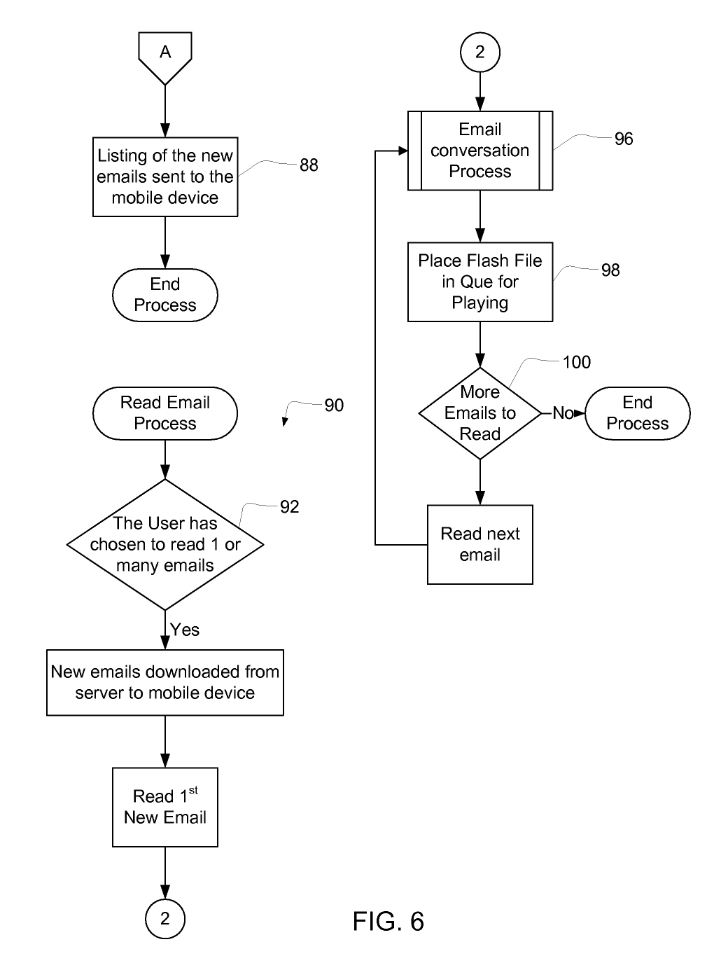

If the user has no new emails, a message 86 is sent to the user 12 informing him that there are no emails and the email reader application 70 is exited 76. If the user 12 has new emails a listing of the new emails is sent to the user 12 and the email reader application is exited 76. The application 70 does not immediately bring the full email down for processing, but rather brings a listing 88 (FIG. 6) of the emails including the following: sender, title, date, time. The emails are handled in this manner for productivity reasons. When the email reader application 70 is active a process will continue to run in the background and poll the email server for new emails.

In FIG. 6, the email reader application 70 further includes an email reading method 90 where the user 12 chooses to read one or more emails 92. The choice may be expressed by the user 12 in a number of ways including but not limited to a voice command, or pushing a play button on the animation player 48. Alternatively, the user 12 can choice the reading method 90 to begin automatically after the listing 88 and that choice can be affected by the user 12 choosing a default option in the email reader application 90. In any event, the first email message is read 94 beginning with an email conversion process 96 which includes an email text message being converted into a flash file and stored on the personal computer 32 (FIG. 1). The flash file is queued for playing 98 and played, and then the email application reader 70 queries 100 whether additional emails need reading. If not, the email reader application 70 exits, else the conversion 96 and playing 98 and query 100 steps are repeated until the emails are exhausted.

When a user 12 selects to read email the first thing the program does is determines if the email chosen to be read is actually on the mobile device. If not, the email will be downloaded from the server. The application 70 can use a commercially available EAGetMail component to connect to the server and download email to the local personal computer 32. The invention can read emails in multiple languages (such as Spanish, Italian, Portuguese, French, German, English) and convert that text into an audio message spoken in the language of the email.

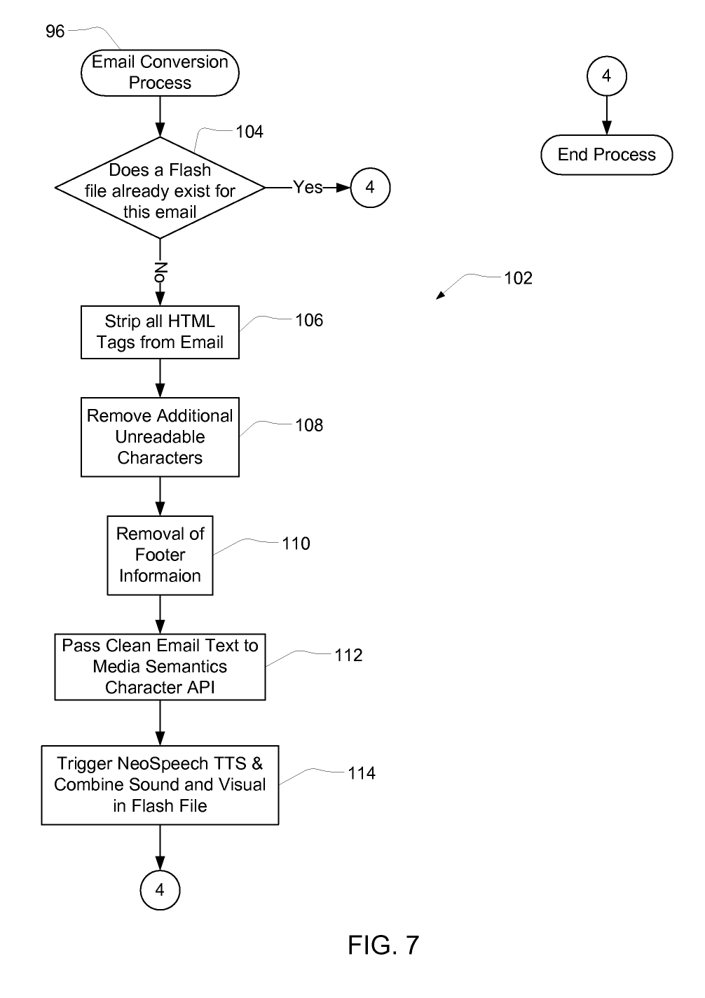

As shown in FIG. 7, the email conversion method 96 includes a subroutine 102. Email conversion subroutine 102 includes a query 104 as to whether a flash file already exists for the email and if so the email conversion subroutine 102 is exited 304. This query 104 exists because each email on mail server 26 has an associated unique identifier, that identifier being a string of characters divided into one or more characters or groups of characters. The characters or groups of characters indicate the source of the email, the target of the email, and other information. The email conversion subroutine 102 strips (or parses) html tags from the email 106, removes additional unreadable characters 108, removes any header and footer 110 that might be in the email and then passes a clean email text to a Media Semantics Character application programming interface (API) 112. The Media Semantics application is available from MediaSemantics.com and P.O. Box 1024, Snowqualmie, Wash. 98065 USA. In response to the the API, a NeoSpeech text-to-speech application combines sound and a visual (avatar) into a flash file 114. The Neo-speech application is available from Neo-Speech, 2051 Landings Drive, Mountain View, Calif. 94043.

It is not until the user begins to play an email that a full email is extracted from the Vivee email server 26 and brought to the mobile device, personal computer 32. At this point the EAGetMail component is used to connect to the mail server through POP3 and bring down the email. The email reader application 70 further includes a play subroutine 116 (FIG. 7). Email play subroutine 116 queries 118 whether there are any flash email files to play and if not the subroutine 116 is exited. If there are email to play, and query 118 is answered in the affirmative, the first email flash file is played 120 and subsequent emails flash files are played one after another until query 122 is answered in the negative.

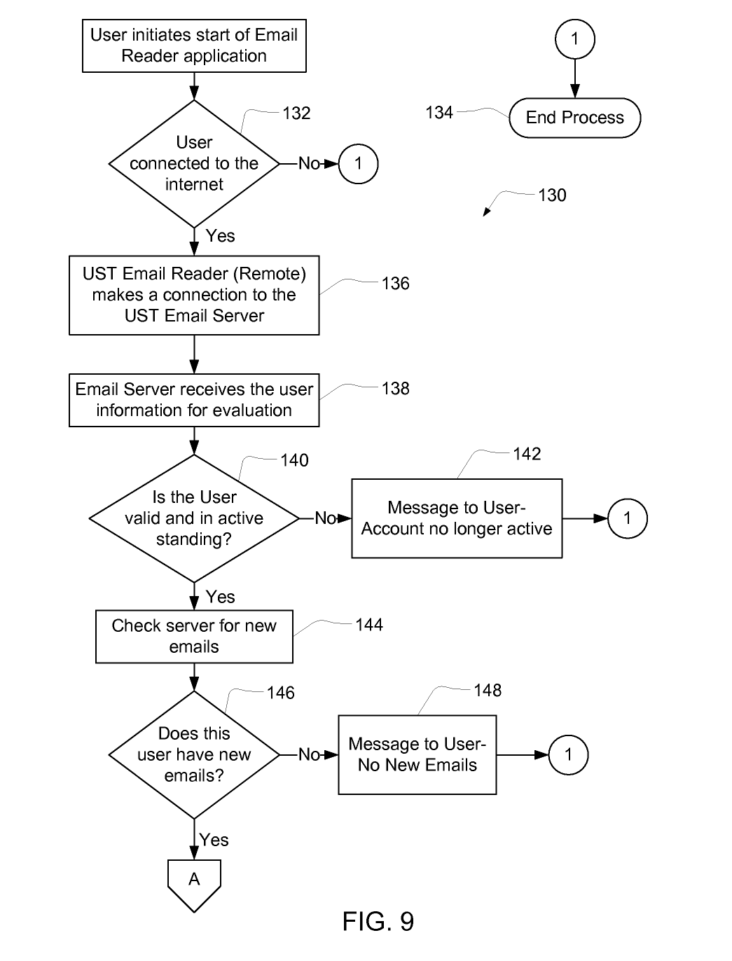

FIG. 9 is a flowchart of the email reader application 130 for use on handheld computer, smartphone, or cellphone. The email reader application 130 is responsible for making the connection to the server, verifying user authority, transfer the emails to the mobile device playing the email. Each customer of this service will receive an email address at Vivee.com. It will be the responsibility of the user to setup forwarding to their Vivee.com email address for any other email accounts they would like to access through the Email Reader.

User 12 starts email reader application 130 which determines 132 if the user 12 is connected to a wireless network (such as the internet) and if not the email reader application 130 ceases 134. Otherwise, the email reader makes a connection 136 to the Vivee mail server 26 (FIG. 4) and then the Vivee mail server 26 gets user information for evaluation 138. The standard internet protocol POP3 is used to make the connection to the server. This user information can include an identity for comparison 140 with a list of active users who have or have not paid their bill for using the invention. By getting the user information, the invention can inform delinquent users of their delinquency and send them a message as to how to resolve the delinquency 142. The invention can receive credit card information in real-time such that subscribers need not be frustrated by a service lapse. Seriously delinquent subscribers can be informed of their status and how they can reactivate their accounts should they choose to do so. If query 140 as to whether the subscriber is valid and active is answered in the negative, the email reader application 130 exits 134. If the query 140 answers in the affirmative the Vivee mail server 26 (FIG. 4) is checked for new emails 144.

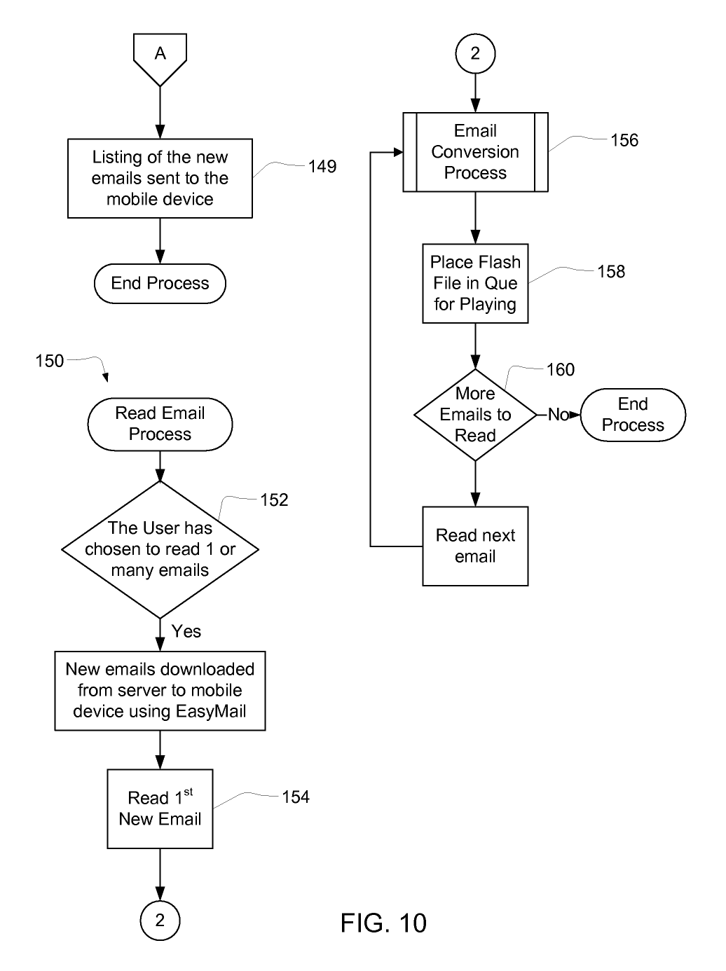

If it is determined that the user 12 has no new emails 146, a message 148 is sent to the user 12 informing him that there are no emails and the email reader application 130 is exited. If the user 12 does have new emails a listing of the new emails is sent to the user 12 and the email reader application 130 is exited. The process does not immediately bring the full email down for processing, but rather brings a listing 149 (FIG. 10) of the emails including the following; sender, title, date, time. The emails are handled in this manner for application productivity reasons. When the email reader application 70 is active a process will continue to run in the background and poll the email server for new emails.

In FIG. 10, the email reader application 130 further includes an email reading method 150 where the user 12 chooses to read one or more emails 152. The choice may be expressed by the user 12 in a number of ways including but not limited to a voice command, or pushing a play button on the animation player 66 (FIG. 4). Alternatively, the user 12 can choice the reading method 150 to begin automatically after the listing 149 and that choice can be affected by the reader choosing a default option in the email reader application 130. When a user 12 selects to read an email the first thing the program does is determines if the email chosen to be read is actually on the mobile device. If not, the email will be downloaded from the server. The application uses the EasyMail component to connect to the server and download the email to the local PC. EasyMail is available from QuickSoftCorp.com. In any event, the first email message is read 154 beginning with an email conversion process 156 which includes an email text message being converted into a flash file and stored on a handheld computer of the user. The flash file is queued for playing 158, and then the email application reader 130 queries whether additional emails need reading 160. If not, the email reader application 130 exits, else the conversion 156 and playing 158 and query 160 steps are repeated until the emails are exhausted.

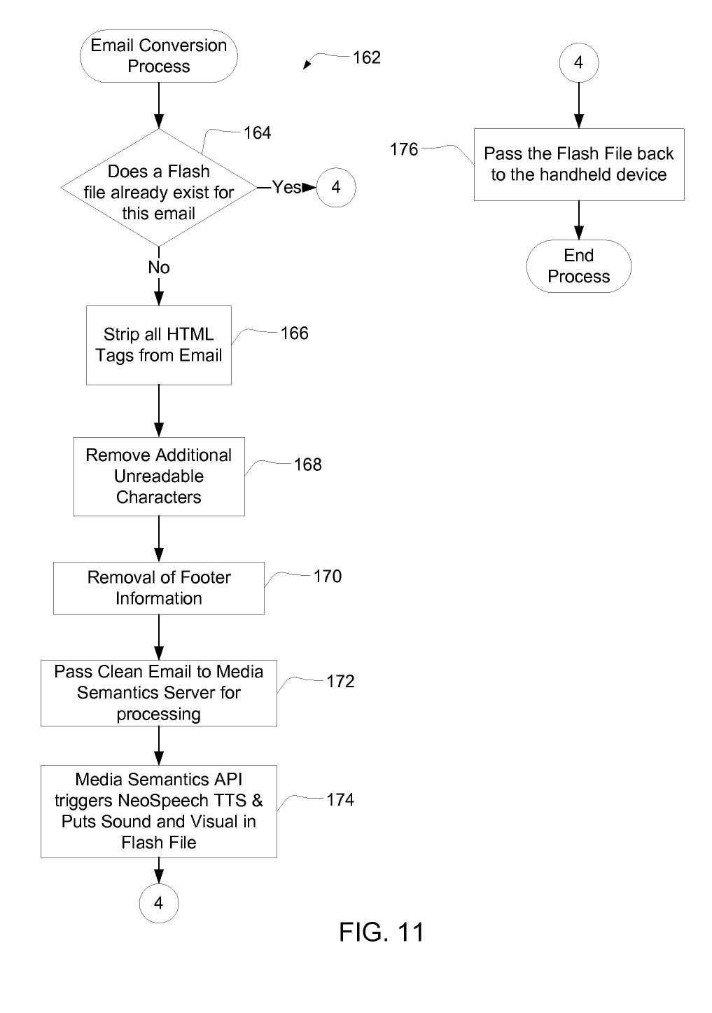

As shown in FIG. 11, the email conversion method 156 includes a subroutine 162. Email conversion subroutine 162 includes a query 164 as to whether a flash file already exists for the email and if so the email conversion subroutine 162 is exited. This query 164 exists because each email on Vivee mail server 26 (FIG. 4) has an associated unique identifier, that identifier being a string of characters divided into one or more characters or groups of characters. The characters or groups of characters indicate the source of the email, the target of the email, and other information. The email conversion subroutine 162 strips (or parses) html tags from the email 166, removes additional unreadable characters 168, removes any header and footer 170 that might be in the email and then passes a clean email text to a Media Semantics Character application programming interface 172. The Media Semantics application is available from MediaSemantics.com and P.O. Box 1024, Snowqualmie, Wash. 98065 USA. In response to the the API, a NeoSpeech text-to-speech application combines sound and a visual (avatar) into a flash file 174. The Neo-speech application is available from Neo-Speech, 2051 Landings Drive, Mountain View, Calif. 94043. The flash file is passed to the handheld device (FIG. 4) for the mail by means of the animation player 66.

It is not until the end user begins to play an email that the full email is extracted from the server and brought to the mobile device. At this point the EAGetMail component is used to connect to the mail server through POP4 and bring down the email. The email reader application 130 further includes a play subroutine 180. Email play subroutine 180 queries 182 whether there are any flash email files to play and if not the subroutine 180 is exited. If there are email to play, the first email flash file is played 184 and subsequent emails flash files are played one after another until query 186 is answered in the negative.

It will be observed that the present invention has apparent utility in a wide variety of fields beyond those described herein. The disclosure herein illustrates the presently-known preferred embodiments for utilizing the technique of the present invention. Additional objects and circumstances are included within the scope of the present invention in accordance with the precepts thereof. All citations referred to herein are incorporated expressly herein by reference.

1. A method for rendering an email, comprising the steps:
providing a personal computer;
connecting the personal computer to a mail server through an internet protocol;
verifying an active user authority associated with that personal computer;
determining whether an email is associated with a user;
transferring said email from the mail server to the personal computer;
performing text to speech conversion on said personal computer in response to said email for providing a speech signal;
said personal computer providing said speech signal to a character animator for providing an animated email by means of an animated avatar;
providing an animation player disposed on a vehicle dashboard so as to be visible by a vehicle driver; and
rendering that animated email on said animation player

2. The method of claim 1, further including connecting the device to a second server which provides instant messages, determining whether an instant message is associated with the user, transferring instant messages from the second server to the mobile device for providing both email and instant messages on said mobile device in audio format spoken by an avatar.

3. A method for rendering an email, comprising the steps:
providing a handheld computing device held by a user, said handheld computing device having a screen;
connecting the handheld computing device to a mail server through an internet protocol;
verifying an active user authority associated with that mobile computer;
determining whether an email is associated with said user;
transferring said email from the mail server to the handheld computing device;
providing said email by means of wireless internet to a character server:
performing text to speech conversion on said character server in response to said email for providing a speech signal;
providing an animated avatar synchronized with said speech signal in response to said email for producing an animated email;
sending said animated email to said handheld computing device; and
rendering said email in audio format spoken by said animated avatar displayed on the screen of said handheld computing device.

3. The method of claim 1, wherein the process of transferring said email occurs in response to a list of emails on the mail server being provided to said personal computer for display on the screen and the user selects at least one email from the list for transfer to the personal computer.

4. The method of claim 3, wherein the process of transferring said email occurs in response to a list of emails on the mail server being provided to said personal computer for display on the screen and the user selects at least one email from the list for transfer to the personal computer.

5. The method of claim 1, further including the steps of parsing the email on the personal computer prior to its being converted to a speech signal.

6. The method of claim 3, further including the steps of parsing the email on the personal computer prior to its being converted to a speech signal.
